(19) United States
(12) Patent Application Publication
(10) Pub. No.: US 2026/0357821 A1
(43) Pub. Date: Nov. 12, 2026

(54) ELECTRICAL BOX INSTALLATION MECHANISM FOR CEILING FAN WITH LAMP

(71) Applicant: AIR COOL INDUSTRIAL CO., LTD., Taichung City (TW)

(72) Inventor: Ken-Tuan Chen, Taichung City (TW)

(21) Appl. No.: 19/200,695

(22) Filed: May 7, 2025

(51) Int. Cl. F04D 29/64; F16M 13/02; F21V 21/112; F21V 33/00

(52) U.S. Cl. CPC F04D 29/646; F16M 13/027; F21V 21/112; F21V 33/0096

(57) ABSTRACT

An electrical box installation mechanism for a ceiling fan with a lamp is disclosed. The electrical box installation mechanism includes a first casing and a second casing that are fixedly connected to a ceiling fan body and a lamp of a ceiling fan. The first casing has a plurality of spaced first fixing holes and at least two protrusions. The second casing has at least two guide rails. When the ceiling fan is to be installed to the ceiling, the first casing and the second casing are connected. The guide rails guide the protrusions of the first casing for the protrusions to enter the guide rails, so that the guide rails and the protrusions form a support relationship, which enables the lamp to be hung by support portions of circumferential rails of the guide rails and the protrusions, thereby enhancing safety and convenience for users working at ceiling height.

### FIELD OF THE INVENTION

The present invention relates to a ceiling fan, and more particularly to an electrical box installation mechanism for a ceiling fan with a lamp.

### BACKGROUND OF THE INVENTION

Conventional ceiling fans are mostly fixed to the ceiling. In order to save the installation space of a lamp, a ceiling fan is usually combined with a lamp under the ceiling fan. With the setting of the lamp, the ceiling fan has a lighting effect.

When the ceiling fan and the lamp are to be assembled, tools are required at ceiling height. This poses greater risks for general household users. The installation process is relatively slow. It is not easy to install the ceiling fan when the lamp is large in size.

When the user works at ceiling height, a hanging structure can be provided to enhance the safety of assembling the ceiling fan and the lamp. Accordingly, the inventor of the present invention has devoted himself based on his many years of practical experiences to solve these problems.

### SUMMARY OF THE INVENTION

The primary object of the present invention is to provide an electrical box installation mechanism for a ceiling fan with a lamp, which improves the convenience and safety for the assembly of the ceiling fan and the lamp.

In order to achieve the foregoing object, the present invention provides an electrical box installation mechanism for a ceiling fan with a lamp. The electrical box installation mechanism is applied to a ceiling fan. The ceiling fan includes a ceiling fan body and a lamp under the ceiling fan body. The electrical box installation mechanism comprises a first casing and a second casing. The first casing is fixedly connected to one of the ceiling fan body and the lamp. The first casing has a first peripheral wall extending longitudinally around one side of the first casing. The first peripheral wall has a plurality of first fixing holes that are transversely spaced apart from one another. The first peripheral wall is fixedly connected to at least two protrusions. The at least two protrusions are arranged transversely. The second casing is fixedly connected to the other one of the ceiling fan body and the lamp. The second casing has a second peripheral wall extending longitudinally around one side of the second casing and corresponding to the first peripheral wall. The second peripheral wall is configured for connecting the first peripheral wall to form an accommodating space. One side of the second peripheral wall is defined as a connecting side. The second peripheral wall is formed with at least two guide rails. The guide rails correspond to the respective protrusions. The guide rails each correspond to a corresponding one of the first fixing holes and a corresponding one of the protrusions. The guide rails each have a guide inlet, a longitudinal rail, a circumferential rail, and a support portion. One end of the longitudinal rail of the guide rail, adjacent to the connecting side, forms the guide inlet. Another end of the longitudinal rail of the guide rail, far away from the connecting side, extending circumferentially to form the circumferential rail. The second peripheral wall is formed with the corresponding support portions at the circumferential rails of the guide rails adjacent to the connecting side.

When the ceiling fan is to be installed to a ceiling, the first casing and the second casing are connected. The guide rails guide the protrusions of the first casing for the protrusions to pass through the longitudinal rails from the guide inlets and enter the circumferential rails of the guide rails, so that the support portions of the guide rails and the protrusions form a support relationship, which enables the lamp to be hung by the support portions of the circumferential rails of the guide rails and the protrusions, thereby enhancing safety and convenience for users working at ceiling height.

### BRIEF DESCRIPTION OF THE DRAWINGS

FIG. 1 is an exploded view of a first embodiment of the present invention;

FIG. 2 is a schematic view of the first embodiment of the present invention when in use;

FIG. 3 is another schematic view of the first embodiment of the present invention when in use;

FIG. 4 is an exploded view of a second embodiment of the present invention; and

FIG. 5 is a schematic view of the second embodiment of the present invention when in use.

### DETAILED DESCRIPTION OF THE PREFERRED EMBODIMENTS

Embodiments of the present invention will now be described, by way of example only, with reference to the accompanying drawings.

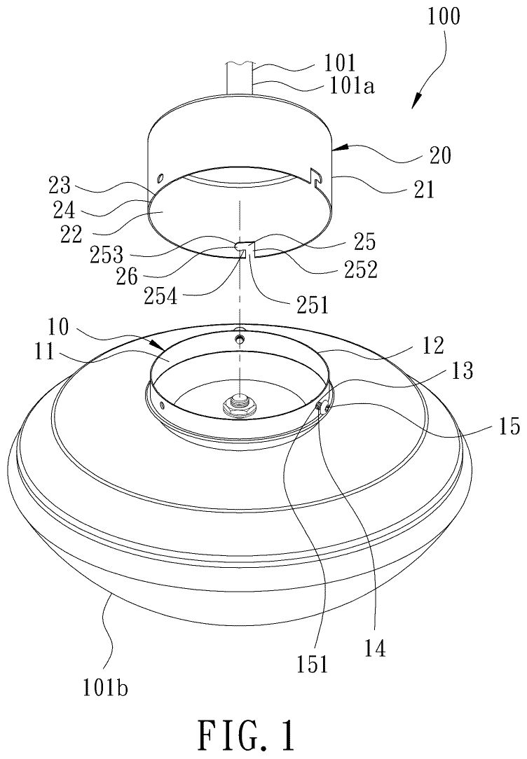

FIGS. 1-3 illustrate a first embodiment of the present invention. The present invention provides an electrical box installation mechanism 100 for a ceiling fan with a lamp. The electrical box installation mechanism can be applied to a ceiling fan 101. The ceiling fan 101 includes a ceiling fan body 101a and a lamp 101b under the ceiling fan body 101a. The electrical box installation mechanism 100 comprises a first casing 10 and a second casing 20.

The first casing 10 is fixedly connected to one of the ceiling fan body 101a and the lamp 101b. The first casing 10 has a first peripheral wall 11 extending longitudinally around one side of the first casing 10. One side of the first peripheral wall 11 is formed with a first opening 12. The first peripheral wall 11 has a plurality of first fixing holes 13 that are transversely spaced apart from one another. The number of the first fixing holes 13 is three or more. The first peripheral wall 11 is fixedly connected to at least two protrusions 14. The at least two protrusions 14 are arranged transversely. The first peripheral wall 11 is fixedly connected with a plurality of screws 15 passing through the first fixing holes 13. The number of the screws 15 is three or more. The screws 15 each have a threaded portion 151. The threaded portions 151 of at least two of the screws 15 are fixedly connected to at least two of the first fixing holes 13, so that the threaded portions 151 of the at least two of the screws 15 form the at least two protrusions 14.

The second casing 20 is fixedly connected to the other one of the ceiling fan body 101a and the lamp 101b. The second casing 20 has a second peripheral wall 21 extending longitudinally around one side of the second casing 20 and corresponding to the first peripheral wall 11. The second peripheral wall 21 is configured for connecting the first peripheral wall 11 to form an accommodating space 22. One side of the second peripheral wall 21 is defined as a connecting side 23. The connecting side 23 of the second peripheral wall 21 is formed with a second opening 24. The second peripheral wall 21 is formed with at least two guide rails 25. The second peripheral wall 21 has a plurality of second fixing holes 23. The number of the second fixing holes 23 is three or more. The screws 15, the first fixing holes 13 and the second fixing holes 26 correspond to one another. The guide rails 25 correspond to the respective protrusions 14. The guide rails 25 each correspond to a corresponding one of the first fixing holes 13 and a corresponding one of the protrusions 14. The guide rails 25 each correspond to a corresponding one of the first fixing holes 13, a corresponding one of the protrusions 14 and a corresponding one of the second fixing holes 26. The guide rails 25 each have a guide inlet 251, a longitudinal rail 252, a circumferential rail 253, and a support portion 254. One end of the longitudinal rail 252 of the guide rail 25, adjacent to the connecting side 23, forms the guide inlet 251. Another end of the longitudinal rail 252 of the guide rail 25, far away from the connecting side 23, extends circumferentially to form the circumferential rail 253. The second fixing holes 26 of the second peripheral wall 21 are formed at the respective distal ends of the circumferential rails 253 of the guide rails 25. The circumferential rails 253 of the guide rails 25 communicate with the respective second fixing holes 26. The second peripheral wall 21 is formed with the corresponding support portions 254 at the circumferential rails 253 of the guide rails 25 adjacent to the connecting side 23.

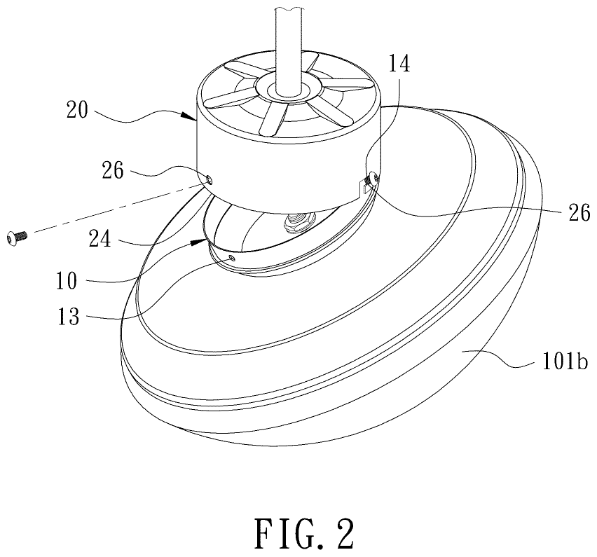

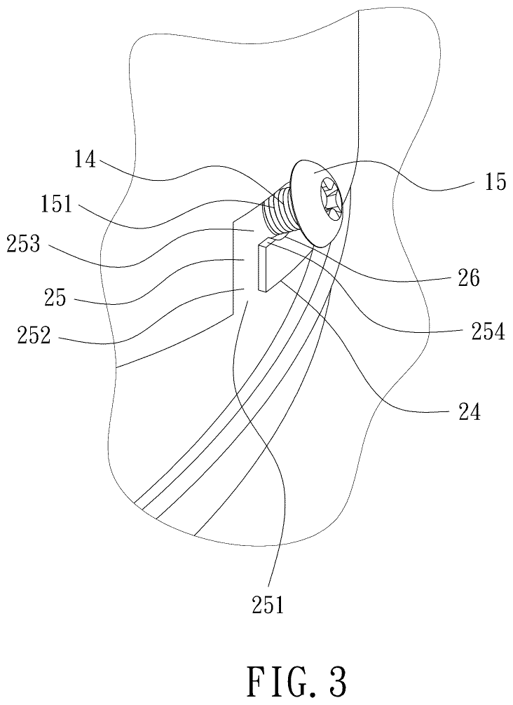

When the ceiling fan is to be installed to the ceiling, two of the first fixing holes 13 of the first casing 10 are first locked with the at least two screws 15 to form the at least two protrusions 14. The first casing 10 and the second casing 20 are connected. The guide rails 25 guide the protrusions 14 of the first casing 10 for the protrusions 14 to pass through the longitudinal rails 252 from the guide inlets 251 and enter the circumferential rails 253 and the second fixing holes 26 sequentially, so that the support portions 254 of the guide rails 25 and the protrusions 14 form a support relationship, which enables the lamp 101b to be hung by the support portions 254 of the circumferential rails 253 of the guide rails 25 and the protrusions 14. The distance between the second fixing holes 26 and the second opening 24 is less than the distance between the circumferential rails 253 and the second opening 24. When the protrusions 14 are guided to the second fixing holes 26, the second fixing holes 26 provide a securing effect on the protrusions 14, as shown in FIG. 2 and FIG. 3, thereby enhancing safety and convenience for users working at ceiling height. Finally, the first fixing holes 13 of the first casing 10 and the second fixing holes 26 of the second casing 20 are locked by the screws 15 to complete the installation.

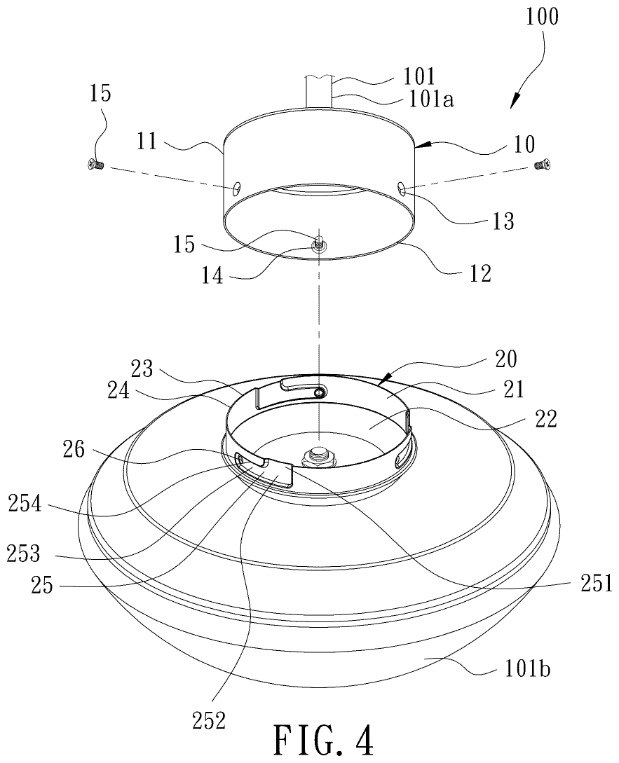

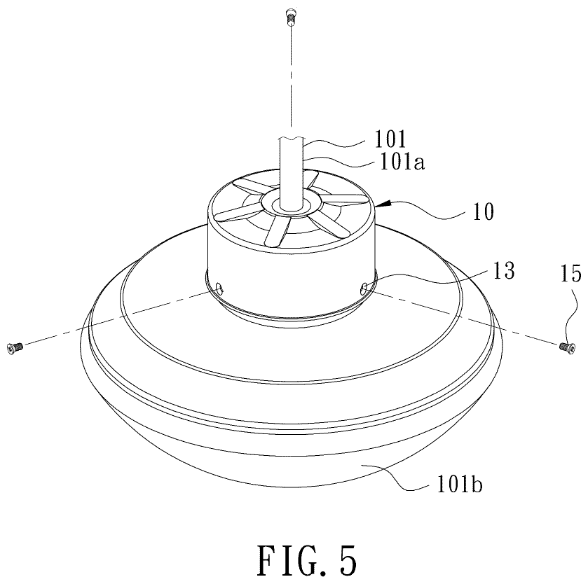

FIG. 4 and FIG. 5 illustrate a second embodiment of the present invention. The second embodiment is substantially similar to the first embodiment with the exceptions described hereinafter. The number of the first fixing holes 13 is three or more. The number of the at least two protrusions 14 is three or more. The protrusions 14 are disposed on the inner side of the first peripheral wall 11. The first casing 10 is formed with the protrusions 14 each extending transversely from the periphery of a corresponding one of the first fixing holes 13. The protrusions 14 are hollow. The first fixing holes 13 pass through the corresponding protrusions 14 for a plurality of screws 15 to pass therethrough. The number of the screws 15 is three or more.

The second embodiment differs from the first embodiment in the following ways. The number of the at least two guide rails 25 is three or more. The guide rails 25 are disposed on the outer side of the second peripheral wall 21. The second peripheral wall 21 is formed with a plurality of second fixing holes 26. The number of the second fixing holes 26 is three or more. The first fixing holes 13, the protrusions 14, the screws 15, the guide rails 25 and the second fixing holes 26 correspond to one another. The guide rails 25 each correspond to a corresponding one of the first fixing holes 13, a corresponding one of the protrusions 14 and a corresponding one of the second fixing holes 26. The second fixing holes 26 each communicate with the distal end of the circumferential rail 253 of the corresponding guide rail 25.

When the ceiling fan is to be installed to the ceiling, the first casing 10 and the second casing 20 are connected. The guide rails 25 guide the protrusions 14 of the first casing 10 for the protrusions 14 to pass through the longitudinal rails 252 from the guide inlets 251 and enter the circumferential rails 253. The guiding process is more stable than in first embodiment. The support portions 254 of the guide rails 25 and the protrusions 14 form a support relationship, which enables the lamp 101b to be hung on the circumferential rails 253 of the guide rails 25 of the first casing 101b, thereby enhancing safety and convenience for users working at ceiling height. Finally, the protrusions 14 are guided to the second fixing holes 26. The first fixing holes 13 of the first casing 10 and the second fixing holes 26 of the second casing 20 are locked by the screws 15 to complete the installation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An electrical box installation mechanism for a ceiling fan with a lamp, applied to a ceiling fan, the ceiling fan including a ceiling fan body and a lamp under the ceiling fan body, the electrical box installation mechanism comprising:
a first casing, fixedly connected to one of the ceiling fan body and the lamp, the first casing having a first peripheral wall extending longitudinally around one side of the first casing, the first peripheral wall having a plurality of first fixing holes that are transversely spaced apart from one another, the first peripheral wall being fixedly connected to at least two protrusions, the at least two protrusions being arranged transversely;
a second casing, fixedly connected to the other one of the ceiling fan body and the lamp, the second casing having a second peripheral wall extending longitudinally around one side of the second casing and corresponding to the first peripheral wall, the second peripheral wall being configured for connecting the first peripheral wall to form an accommodating space, one side of the second peripheral wall being defined as a connecting side, the second peripheral wall being formed with at least two guide rails, the guide rails corresponding to the respective protrusions, the guide rails each corresponding to a corresponding one of the first fixing holes and a corresponding one of the protrusions, the guide rails each having a guide inlet, a longitudinal rail, a circumferential rail and a support portion, one end of the longitudinal rail of the guide rail, adjacent to the connecting side, forming the guide inlet, another end of the longitudinal rail of the guide rail, far away from the connecting side, extending circumferentially to form the circumferential rail, the second peripheral wall being formed with the corresponding support portions at the circumferential rails of the guide rails adjacent to the connecting side;
wherein when the ceiling fan is to be installed to a ceiling, the first casing and the second casing are connected, and the guide rails guide the protrusions of the first casing for the protrusions to pass through the longitudinal rails from the guide inlets and enter the circumferential rails of the guide rails, so that the support portions of the guide rails and the protrusions form a support relationship, which enables the lamp to be hung by the support portions of the circumferential rails of the guide rails and the protrusions.

2. The electrical box installation mechanism as claimed in claim 1, wherein the number of the first fixing holes is three or more, the first peripheral wall is fixedly connected with a plurality of screws passing through the first fixing holes, the number of the screws is three or more, the screws each have a threaded portion, the threaded portions of at least two of the screws are fixedly connected to at least two of the first fixing holes so that the threaded portions of the at least two of the screws form the at least two protrusions, the second peripheral wall has a plurality of second fixing holes, the number of the second fixing holes is three or more, the screws, the first fixing holes and the second fixing holes correspond to one another, the guide rails each correspond to a corresponding one of the first fixing holes, a corresponding one of the protrusions and a corresponding one of the second fixing holes, the second fixing holes of the second peripheral wall are formed at respective distal ends of the circumferential rails of the guide rails, the circumferential rails of the guide rails communicate with the respective second fixing holes, the protrusions are guided to the respective second fixing holes, and the first fixing holes of the first casing and the second fixing holes of the second casing are locked by the screws.

3. The electrical box installation mechanism as claimed in claim 1, wherein the number of the first fixing holes is three or more, the number of the at least two protrusions is three or more, the first casing is formed with the protrusions each extending transversely from a periphery of a corresponding one of the first fixing holes, the protrusions are hollow, the first fixing holes pass through the respective protrusions for a plurality of screws to pass therethrough, the number of the screws is three or more, the number of the at least two guide rails is three or more, the second peripheral wall is formed with a plurality of second fixing holes, the number of the second fixing holes is three or more, the first fixing holes, the protrusions, the screws, the guide rails and the second fixing holes correspond to one another, the guide rails each correspond to a corresponding one of the first fixing holes, a corresponding one of the protrusions and a corresponding one of the second fixing holes, the second fixing holes communicate with respective distal ends of the circumferential rails of the guide rails, the protrusions are guided to the respective second fixing holes, and the first fixing holes of the first casing and the second fixing holes of the second casing are locked by the screws.

4. The electrical box installation mechanism as claimed in claim 2, wherein one side of the first peripheral wall is formed with a first opening, and the connecting side of the second peripheral wall is formed with a second opening.

5. The electrical box installation mechanism as claimed in claim 4, wherein a distance between the second fixing holes and the second opening is less than a distance between the circumferential rails of the guide rails and the second opening.

6. The electrical box installation mechanism as claimed in claim 3, wherein one side of the first peripheral wall is formed with a first opening, and the connecting side of the second peripheral wall is formed with a second opening.
